(19) United States
(12) Patent Application Publication
(10) Pub. No.: US 2009/0210942 A1
(43) Pub. Date: Aug. 20, 2009

(54) DEVICE, SYSTEM AND METHOD OF ACCESSING A SECURITY TOKEN

(76) Inventor: Gil Abel, Rishon LeZion (IL)

Correspondence Address: EMPK & Shiloh, LLP;c/o Landon IP, Inc., 1700 Diagonal Road, Suite 450, Alexandria, VA, 22314, US

(21) Appl. No.: 12/279,987

(22) PCT Filed: Feb. 20, 2007
(86) PCT No.: PCT/IL07/00226

§ 371 Date: Aug. 20, 2008

Related U.S. Application Data
(60) Provisional application No. 60/774,660, filed on Feb. 21, 2006.

(51) Int. Cl. H04L 9/32; G06F 21/00

(52) U.S. Cl. 726/20

(57) ABSTRACT

Some demonstrative embodiments of the invention relate to a method, device and system of accessing a security token. One demonstrative embodiment of the invention includes a security token to securely maintain one or more protected resources, the security token including a token application to authenticate a first request to access the protected resources based on user authentication data assigned to a user of the security token, generate an output including an authentication ticket different from the user authentication data, and authenticate a second request to access the protected resources based on the authentication ticket. Other embodiments are described and claimed.

### CROSS REFERENCE TO RELATED APPLICATIONS

This application claims the benefit of U.S. Provisional Application No. 60/774,660, filed Feb. 21, 2006, the entire disclosure of which is incorporated herein by reference.

### BACKGROUND

A security token, also referred to as a hardware token, an authentication token or a cryptographic token, may include a physical device which may be used to authenticate a user when interfacing with a station, which may include for example, a computing platform, e.g., a Personal Computer (PC), or a cellular telephone.

Some security tokens may be implemented in the form of a smart card, i.e., a portable medium having a semiconductor chip capable of performing desired operations and storing desired data. In some implementations, the semiconductor chip may have a Self Programmable One-chip Microcomputer (SPOM) architecture, which may enable securely handling multiple applications using self-programmable operations and storing data in a non-volatile memory.

The security token may be coupled by a token terminal or a token reader to the station. The token terminal may enable transferring data between the security token and the station.

In some configurations the security token may be implemented as a contact token, wherein the token may be physically connected to the token terminal, e.g., via dedicated connectors. The token terminal may, for example, provide the security token with electrical power, and/or a clock signal, which may be needed for operating the security token.

In other configurations the security token may be implemented as a contactless token, wherein the token may communicate with the terminal via a suitable wireless communication channel, e.g., using Radio Frequency (RF) signals.

In some configurations, the station and/or the token terminal may include a user interface, e.g., a keypad, a keyboard or a biometric interface, to receive Card-Holder-Verification (CHV) data (“the entered CHV data”), e.g., a personal identification number (PIN) code, which may be used for authenticating a holder of the security token.

The security token may securely store protected resources, e.g., protected keys and/or files. The security token may enable accessing the protected resources only if the entered CHV data is authenticated. The security token may include, for example, a security status indicator to indicate whether or not access to the protected resources is to be allowed.

Conventional methods of accessing the security token may include performing an authentication procedure, e.g., during an attempt to access the protected resources (“the transaction”). For example, if the station includes the user interface, then the station may transfer to the terminal a verification command, denoted Verify(CHV), including the entered CHV data; and the terminal may transfer the Verify(CHV) command to the token. Alternatively, the terminal may include a Secure Terminal (ST) including a user interface to receive the entered CHV data directly from the user. In this case, the station may transfer to the ST a pseudo verification command, denoted Verify(CHV′), including pseudo CHV data, denoted CHV′. Upon receiving the pseudo verification command, the user may enter the CHV data to the ST, and the ST may transfer to the token the Verify(CHV) command based on the entered CHV data received via the user interface of the ST.

Upon receiving the Verify(CHV) command, the token may perform an authentication operation to authenticate the entered CHV data, e.g., by comparing the entered CHV data to CHV data stored by the token (“the stored CHV data”) and/or based on any other suitable verification/authentication method.

The token may set the security status indicator to an “access enable” state indicating access to the protected resources is allowed, e.g., if the authentication of the entered CHV data succeeds. Optionally, the token may transfer to the host, e.g., via the terminal, a “success” status message indicating the access to the protected resources is allowed.

The token may set the security status indicator to an “access deny” state indicating access to the protected resources is prohibited, e.g., if the authentication of the entered CHV data fails. Optionally, the token may transfer to the host, e.g., via the terminal, a “fail” status message indicating the access to the protected resources is prohibited.

Upon receiving the “success” status message, the station may internally store the entered CHV data as authenticated CHV data, e.g., for use in future transactions. As long as the security status indicator is at the “access enable” state, the station may access and/or retrieve from the token the protected resources, e.g., using suitable token access commands.

The station may transfer to the token a security status clear command upon completing the transaction. After receiving the clear command, the token may reset the security status indicator to the “access deny” state.

Unfortunately, the conventional methods of accessing the token may not provide sufficient protection against unauthorized disclosure of the CHV data to an attacker. For example, the attacker may attempt to detect the CHV data entered via the host user interface, e.g., if a ST is not implemented. Additionally or alternatively, the attacker may retrieve the authenticated CHV data internally stored by the host.

The protection against unauthorized disclosure may be enhanced, for example, by implementing the ST, which may not transfer the CHV data to the host; and/or by not storing the authenticated CHV data by the host, e.g., if the CHV data is entered via the ST. However, in such a case the token holder may be required to enter the CHV data for every transaction. This may also affect the efficiency of the communication between the host and the token. In some implementations the security status indicator may not be cleared at the end of the transaction, e.g., in order to enable performing a series of transactions without requiring the user the re-enter the CHV data. Such implementations may result in a reduced security level, since an attacker may access the token between the transactions.

### SUMMARY

Some demonstrative embodiments of the invention relate to a method, device and system of accessing a security token.

According to some demonstrative embodiments, a security token to securely maintain one or more protected resources may include a token application to authenticate a first request to access the protected resources based on user authentication data assigned to a user of the security token. The token application may also generate an output including an authentication ticket different from the user authentication data. The token application may also authenticate a second request to access the protected resources based on the authentication ticket.

According to some demonstrative embodiments, the token application may invalidate the authentication ticket based on predefined criteria, and deny one or more requests to access the protected resources using the invalid authentication ticket.

According to some demonstrative embodiments, the security token may receive the authentication data during a session with a station. The token application may also invalidate the authentication ticket if the session is terminated.

According to some demonstrative embodiments, the token application may invalidate the authentication ticket, e.g., if communication with the station is disrupted or terminated.

According to some demonstrative embodiments, the token application may invalidate the authentication ticket a predefined time period after generating the authentication ticket.

According to some demonstrative embodiments, the token application may generate a success status message indicating that access to the protected resources is allowed.

According to some demonstrative embodiments, the user authentication data may include card-holder-verification data.

According to some demonstrative embodiments, a data size of the authentication ticket may be smaller than a data size of the user authentication data. For example, the data size of the authentication ticket may be smaller than or equal to 128 bits, e.g., smaller than or equal to 64 bits.

According to some demonstrative embodiments, the security token may include, for example, a universal-serial-bus token or a secure-digital token.

According to some demonstrative embodiments, a method of accessing one or more protected resources of a security token may include providing the security token with user authentication data to authenticate a first request to access the protected resources; receiving from the security token an authentication ticket different from the user authentication data; and providing the security token with the ticket to authenticate a second request to access the protected resources subsequent to the first request.

According to some demonstrative embodiments, the method may include maintaining a value corresponding to the authentication ticket externally to the security token.

According to some demonstrative embodiments, the method may include invalidating the authentication ticket based on predefined criteria. For example, the invalidating may result in denying one or more requests to access the protected resources using the authentication ticket.

According to some demonstrative embodiments, providing the authentication data may include providing the authentication data during a session with the security token. Invalidating the authentication ticket may include invalidating the authentication ticket if the session is terminated.

According to some demonstrative embodiments, invalidating the authentication ticket may include invalidating the authentication ticket if communication with the security token is disrupted or terminated.

According to some demonstrative embodiments, invalidating the authentication ticket may include invalidating the authentication ticket a predefined time period after the authentication ticket has been provided by the security token.

According to some demonstrative embodiments, the method may include receiving from the security token a success status message indicating that access to the protected resources is allowed.

According to some demonstrative embodiments, the method may include receiving the user authentication data from a user of the security token.

### BRIEF DESCRIPTION OF THE DRAWINGS

Some embodiments of the invention, both as to organization and method of operation, together with features and advantages thereof, may best be understood by reference to the following detailed description when read with the accompanied drawings in which:

FIG. 1 schematically illustrates a security token system, in accordance with some demonstrative embodiments of the invention; and

FIG. 2 schematically illustrates a flow-chart of a method of accessing a security token, in accordance with some demonstrative embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF SOME DEMONSTRATIVE EMBODIMENTS OF THE INVENTION

In the following detailed description, numerous specific details are set forth in order to provide a thorough understanding of embodiments of the invention. However, it will be understood by those of ordinary skill in the art that embodiments of the invention may be practiced without these specific details. In other instances, well-known methods, procedures, components, units and/or circuits have not been described in detail so as not to obscure the invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Some embodiments of the invention may be implemented, for example, using a machine-readable medium or article which may store an instruction or a set of instructions that, if executed by a machine (for example, by a processor and/or by other suitable machines), cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

It should be understood that embodiments of the invention may be used in a variety of applications. Although the invention is not limited in this regard, embodiments of the invention may be used in conjunction with many apparatuses, for example, a server, a wireless communication device, a personal computer, a desktop computer, a mobile computer, a laptop computer, a notebook computer, a Personal Digital Assistant (PDA) device, a tablet computer, a server computer, a network, a wireless network, a Local Area Network (LAN), a Wireless LAN (WLAN), a cellular telephone, a wireless telephone, a Personal Communication Systems (PCS) device, a PDA device which incorporates a wireless communication device, or the like. It is noted that embodiments of the invention may be used in various other apparatuses, devices, systems and/or networks.

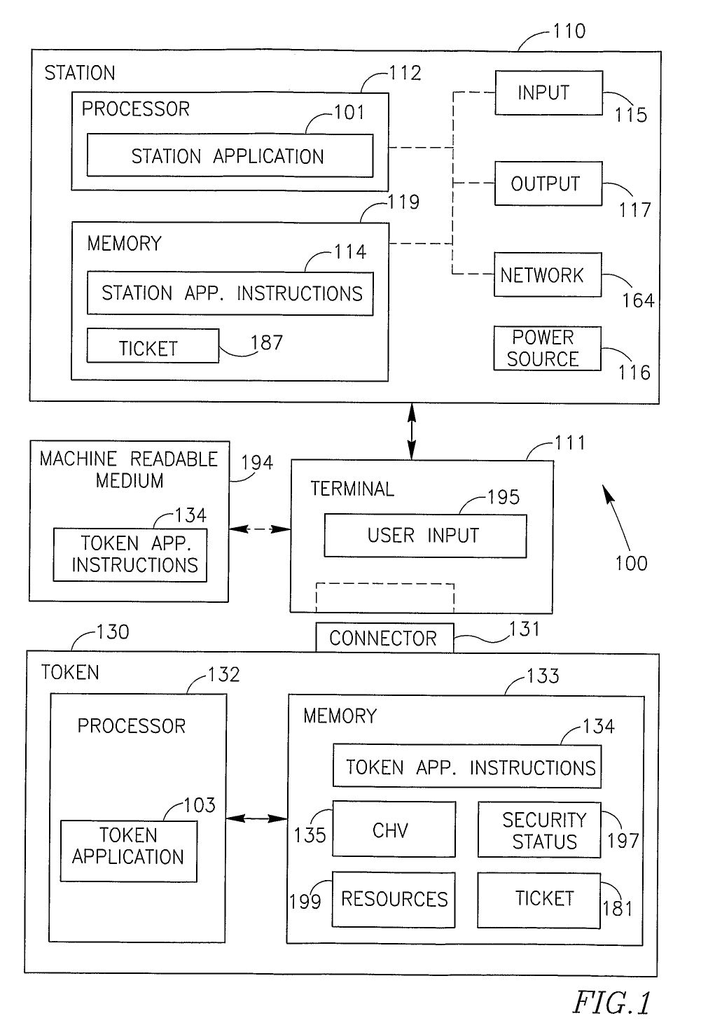

Reference is made to FIG. 1, which schematically illustrates a security token system 100, in accordance with some demonstrative embodiments of the invention.

According to some demonstrative embodiments of the invention, system 100 may include at least one station 110, which may be able, for example, to serve at least one user; and at least one security token 130, e.g., as are described in detail below.

Although the present invention is not limited in this respect, station 110 may be a portable device. Non-limiting examples of such portable devices include mobile telephones, laptop and notebook computers, PDAs, memory cards, memory units, and the like. Alternatively, station 110 may be a non-portable device, such as, for example, a desktop computer.

According to some demonstrative embodiments of the invention, security token 130 may include any suitable physical device, which may be used to authenticate a user when interfacing with station 110. Although the invention is not limited in this respect, in some demonstrative embodiments, token 130 may be implemented as any suitable dedicated security token, e.g., including any suitable hardware token, authentication token, cryptographic token, or smartcard configuration. In other embodiments, token 130 may be implemented as part of a portable device, e.g., a mobile telephone, a PDA, a memory card, and the like. In one example, token 130 may be implemented as part of a mobile telephone, and station 100 may be implemented as a PC.

In some demonstrative embodiments of the invention, token 130 may include a contact security token configuration, e.g., a universal serial bus (USB) token configuration, or a Secure Digital (SD) token configuration. In other demonstrative embodiments, token 130 may include a contactless security token configuration, e.g., a Bluetooth token configuration.

According to some demonstrative embodiments of the invention, system 100 may also include a token terminal 111 to couple token 130 to station 110. Token terminal 111 may include any suitable token terminal or token reader, e.g., as are known in the art. For example, token terminal 111 may be used to write data to token 130 and/or receive data from token 130.

In one demonstrative embodiment, token terminal 111 may be implemented, for example, by an optical or electronic reading device, e.g., as is known in the art. Alternatively, token terminal 111 may be implemented, for example, in the form of a USB connection, a SD card connection, and/or using any other suitable token terminal hardware and/or software, e.g., as are known in the art.

In another demonstrative embodiment of the invention, terminal 111 may include a contactless terminal able to communicate with token 130, e.g., over a wireless communication channel, as known in the art.

Aspects of the invention are described herein in the context of a demonstrative embodiment of a station, e.g., station 110, and a token terminal, e.g., token terminal 111, implemented as separate units of a security token system, e.g., system 100. However, it will be appreciated by those skilled in the art that, according to other embodiments of the invention, any other combination of integrated or separate units may also be used to provide the desired functionality. For example, in some embodiments of the invention the token terminal may be implemented as part of the station, e.g., as a peripheral module.

According to some demonstrative embodiments of the invention, station 110 may include a processor 112, a memory 119, an input unit 115, an output unit 117, a network connection 164, and/or any other suitable hardware and/or software components. Network connection 164 may interact with a communication network, for example, a LAN, WAN, or a global communication network, for example, the Internet. According to some embodiments the communication network may include a wireless communication network such as, for example, a WLAN communication network. Although the scope of the present invention is not limited in this respect, the communication network may include a cellular communication network, with station 110 being, for example, a base station, a mobile station, or a cellular handset. The cellular communication network, according to some embodiments of the invention, may be a 3GPP, such as, for example, FDD, GSM, WCDMA cellular communication network and the like.

According to some demonstrative embodiments of the invention, processor 112 may include, for example, a Central Processing Unit (CPU), a Digital Signal Processor (DSP), a microprocessor, a controller, a chip, a microchip, an Integrated Circuit (IC), or any other suitable multi-purpose or specific processor or controller, e.g., as are known in the art. Input unit 115 may include, for example, a keyboard; a mouse; a touch-pad; a keypad; a biometric input device, e.g., a fingerprint scanner, and/or camera for scanning a face or an eye; and/or any other suitable pointing device or input device.

Output unit 107 may include, for example, a Cathode Ray Tube (CRT) monitor, a Liquid Crystal Display (LCD) monitor, or other suitable monitor or display unit. Memory 119 may include, for example, a Random Access Memory (RAM), an Erasable Programmable ROM (EPROM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, a hard disk drive or other suitable non-removable storage units or other suitable memory units or storage units.

According to some demonstrative embodiments of the invention, memory 119 may store one or more station application instructions 114 which, when executed by processor 112, may result in a station application 101. Station application 101 may include, for example, a connection management application, for example, to manage a connecting and/or transferring data between station 110 and token 130, e.g., as is known in the art. Station application 101 may also include a user interface application, e.g., as is known in the art. For example, the user interface application may receive from a holder of token 130 Card-Holder-Verification (CHV) data (“the entered CHV data”) in order, for example, to authenticate the holder of token 130. The user interface application may also transfer, for example, the entered CHV data to token 130, e.g., via terminal 111 as is known in the art. The user interface application may be implemented by any suitable program, method and/or process, e.g., as are known in the art.

The term “CHV data” as used herein may relate to an authentication, identification, and/or verification code, key, cipher, method, mechanism and/or algorithm, which may be implemented, for example, by a string or a sequence, of letters, numbers, signs, symbols and the like. For example, the CHV data may include a personal identification number (PIN) code, as is known in the art. Additionally or alternatively, the CHV data may be implemented using any other suitable coding and/or identification method, e.g., a biometric identification method, which may include, for example, checking a fingerprint or the like. For example, a biometric identification algorithm, e.g., which may be executed by token 130, may verify whether, for example, a fingerprint applied by the user matches a stored fingerprint. In such a case, the CHV data may include, for example, data, e.g., a set of values, representing one or more fingerprint attributes. The CHV data may be implemented using any other suitable method, for example, a code for authenticating a challenge/response, e.g., as is known in the art.

According to some demonstrative embodiments of the invention, token terminal 111 may include a Secure Terminal (ST) configuration, e.g., as is known in the art. For example, terminal 111 may include a user input interface 195 to enable the holder of token 130 to enter the CHV data. User input 195 may include, for example, a keyboard; a keypad; a mouse; a touch-pad; a biometric input device, e.g., a fingerprint scanner, and/or camera for scanning a face or an eye; and/or any other suitable pointing device or input device. In other embodiments of the invention token terminal 111 may not include a ST configuration, i.e., terminal 111 may not include input 195. Implementing input unit 195 as part of terminal 111, e.g., instead of or in addition to the user interface application of station 110, may result in an enhanced security, e.g., since the entered CHV data may be provided directly to token 130.

According to some demonstrative embodiments of the invention, token 130 may include a terminal connector 131, which may interface with token terminal 111. Terminal connector 131 may include any suitable terminal connector, e.g., as is known in the art. For example, terminal connector 131 may be implemented by physical electronic contacts, e.g., a gold connector plate, as is known in the art. In one example, connector 131 may include a USB connector, as is known in the art, e.g., if token 130 is implemented as a USB token. In another example, connector 131 may include a SD connection, as is known in the art, e.g., if token 130 is implemented as a SD card.

According to other demonstrative embodiments of the invention, terminal connector 131 may include a contactless or wireless communication module able to contactlessly couple token 130 to terminal 111. For example, connector 131 may include a Radio Frequency (RF) module implementing a suitable RF technology, e.g., Bluetooth technology, to communicate with terminal 111 via RF signals, e.g., as is known in the art.

According to some demonstrative embodiments of the invention, token 130 may also include a processor 132, and/or a memory 133. Although the invention is not limited in this respect, in some embodiments processor 132 and/or memory 133 may be implemented, for example, by a Self Programmable One-chip Microcomputer (SPOM) architecture, e.g., as is known in the art.

In some demonstrative embodiments of the invention token 130, memory 133 and/or processor 132 may be protected by any suitable protection mechanism, e.g., any suitable “physical” protection structure and/or any other suitable protection configuration as is known in the art, to prevent the disclosure of any part of the contents of memory 133, to prevent any attempt to access any part of the contents of memory 133, to prevent any attempt to tamper or alter the contents of memory 133, in part or in whole, and/or to prevent any attempt to interfere with the operation processor 132 and/or memory 133. Token 130 may optionally include any other suitable hardware and/or software components, e.g., as are known in the art.

According to some demonstrative embodiments of the invention, memory 133 may store one or more token application instructions 134, which when executed by processor 132, may result in a token application 103. Token application may perform one or more operation, for example, including operations of an application for communicating between token 130 and station 110, e.g., as is known in the art.

Although the invention is not limited in this respect, in some demonstrative embodiments of the invention, token application instructions 134 may be provided (“uploaded”) to memory 133 from a machine-readable medium or article 194, e.g., via terminal 111. Medium 194 may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, CD-ROM, CD-R, CD-RW, optical disk, magnetic media, various types of DVDs, a tape, a cassette, or the like. Although the invention is not limited in this respect, in one demonstrative embodiment, medium 199 may be connected to or implemented as part of station 110.

According to some demonstrative embodiments of the invention, token application 103 may also be able, for example, to authenticate the holder of token 130, e.g., by determining whether the entered CHV data matches predefined CHV data 135 (“the user CHV data”) assigned to token 130, e.g., as is known in the art. The user CHV data may include, for example, an authentication code, which may include a series of digits and/or letters, e.g., 1, D, t, 4, 2, and the like. According to some demonstrative embodiments of the invention, memory 133 may optionally store user CHV data 135. In other embodiments the user CHV data may not be stored in memory 133.

According to some demonstrative embodiments of the invention, memory 133 may also store protected resources 199, e.g., protected keys, files, certificates, digital signature information, authentication information, and/or any other data or information intended to be accessed by an authorized user of token 130. Memory 133 may also store, for example, a security status indicator 197 to indicate whether or not access to protected resources 199 is to be allowed. For example, application 103 may set indicator 197 to a first value, e.g., one, representing an “access enable” state indicating access to protected resources 199 is allowed, e.g., if the entered CHV data is authenticated. Application 103 may set indicator 197 to a second value, e.g., zero, representing an “access deny” state indicating access to protected resources 199 is prohibited, e.g., if the authentication of the entered CHV data fails.

In some demonstrative embodiments of the invention, token 130 may not include an internal power supply source. Electrical power may be supplied to token 130 by a power source associated with station 110. For example, electrical power may be supplied to token 130 by a power source 116, e.g., via token terminal 111. Power source 116 may be internal or external to station 110, e.g., as is known in the art. Optionally, station 110 may also provide a clock signal may also be provided to token 130 by station 110. For example, processor 112 may provide token 130 with clock signals, e.g., via terminal 111, as is known in the art. Accordingly, power source 116 may provide token 130 with electrical power during a time period (“the session”), e.g., in which token 130 communicates with station 110. For example, the session may begin substantially when token 130 is connected to terminal 111; and/or may end substantially when token 130 is disconnected from terminal 111, and/or the communication between token 130 and station 110 is disrupted or terminated.

According to some demonstrative embodiments of the invention, the user of token 130 may couple token 130 to station 110, for example, by coupling connector 131 to terminal 111, e.g., as is known in the art. In one example, the user may connect connector 131 to terminal 111, e.g., if token 130 includes a contact token. In another example, the user may place token 130 in proximity to terminal 111 to enable contactless coupling between token 130 and terminal 111.

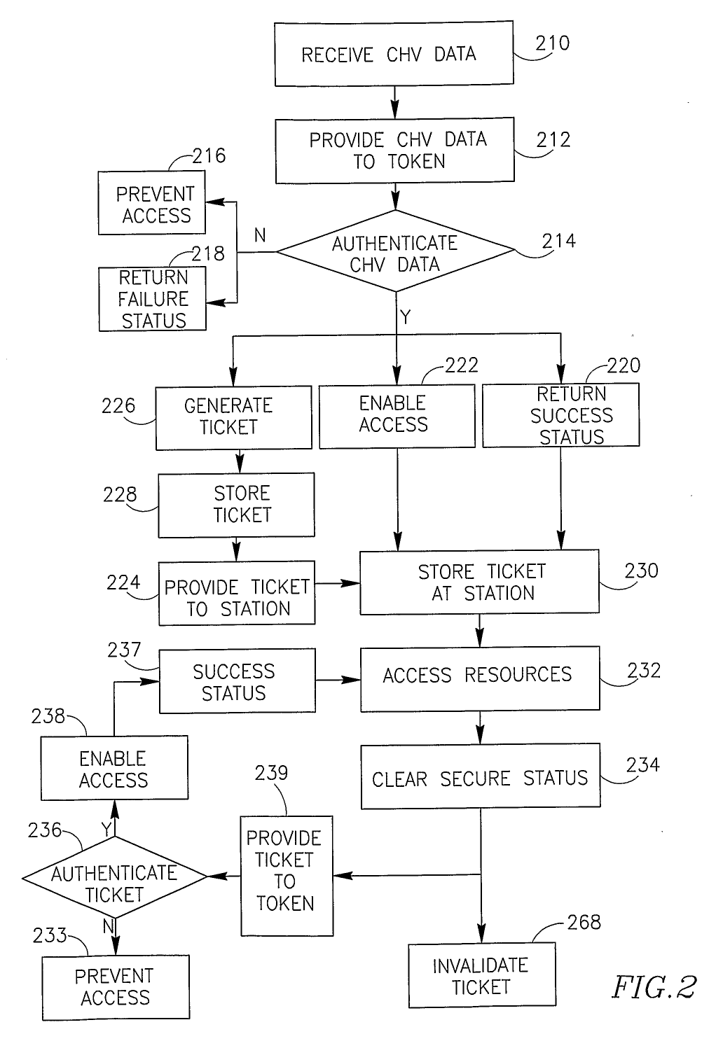

According to some demonstrative embodiments of the invention, in order to authenticate the user, e.g., during an attempt to access the protected resources (“the transaction”), the user may enter CHV data, for example, via the user interface application of station 110, e.g., if terminal 111 does not include a ST; or via user input interface 195, e.g., if terminal 111 includes a ST. The entered CHV data may be transferred to token 130. For example, if the CHV data is entered at station 110, then the CHV data may be transferred from station 110 to terminal 111, e.g., using a verify command as described below with reference to FIG. 2. The CHV data may be transferred from terminal 111 to token 130, e.g., using the verify command as described below with reference to FIG. 2. Token application 103 may attempt to authenticate the user, e.g., by comparing the entered CHV data to the user CHV data. The user may be authenticated, e.g., if the entered CHV data is determined to match the user CHV data.

According to some demonstrative embodiments of the invention, token application 103 may set status indicator 197 to the access enable state, e.g., if the user is authenticated.

According to some demonstrative embodiments of the invention, token application 103 may generate an authentication ticket 181 (“the ticket”), which may be stored, for example, in memory 133. The ticket may include, for example, any suitable, data, code, value, cipher or string, e.g., including one or more symbols. Letters, characters, and/or signs, and the like. Although the invention is not limited in this respect, in some demonstrative embodiments of the invention the ticket may have a predefined length or size. Although the invention is not limited in this respect, the ticket may have, for example, a smaller data size in comparison to the CHV data. For example, the ticket may have a size of between 48 and 128 bits, e.g., 64 bits. The ticket may be generated using any suitable software and/or hardware. For example, token application 103 may generate the ticket using a Random Number Generator (RNG), e.g., as is known in the art, or any other suitable method of generating data, e.g., randomly.

Although the invention is not limited in this respect, in some demonstrative embodiments of the invention, ticket 181 may be defined as a session object, i.e., token application 103 may generate ticket 181 corresponding to a session. For example, token application 103 may generate a new authentication ticket, e.g., following the connection of token 130 to terminal 111. The authentication ticket may be invalidated, cleared, or erased, for example, at the end of the session, e.g., upon disconnecting token 130 from terminal 111, as described below with reference to FIG. 2.

According to some demonstrative embodiments of the invention, token application 103 may also transfer the ticket to station 110, which may store a cached ticket value 187 corresponding to the ticket, e.g., in memory 119. Cached ticket 187 may require less memory resources of memory 119 compared, for example, to the memory resources, which may be required for storing the entered CHV data, e.g., if the ticket has a smaller data size compared to the CHV data. Station application 101 may use the ticket when attempting to perform further transactions with token 120, e.g., instead of using the user CHV data. For example, application 101 may provide token application 103 with the ticket, e.g., instead of the CHV data, as part of the authenticating process for accessing resources 199, as described below with reference to FIG. 2.

Reference is made to FIG. 2, which is schematically illustrates a method of accessing a security token, in accordance with some demonstrative embodiments of the invention. Although the invention is not limited in this respect, the method of FIG. 2 may be implemented by one or more elements of a security token system, e.g., system 100 (FIG. 1), for example, in order to enable a station, e.g., station 110 (FIG. 1), to access protected resources, e.g., resources 199 (FIG. 1) stored by a security token, e.g., token 130 (FIG. 1).

As indicated at block 210, according to some demonstrative embodiments of the invention, the method may include receiving CHV data (“the entered CHV data”) from a holder of the token (“the token holder”). Although the invention is not limited in this respect, the entered CHV data may be received from the holder, for example, upon coupling of the token to a terminal, e.g., terminal 111 (FIG. 1), communicating between the token and the station. In another example, the entered CHV data may be received from the user when the station initiates a transaction attempting to access protected resources, e.g., protected resources 199 (FIG. 1), stored by the security token; the station does not have an updated cached ticket 187 (FIG. 1); and/or ticket 181 (FIG. 1) is not valid, e.g., as described herein.

In one demonstrative embodiment of the invention, the token holder may provide the station with the entered CHV data, e.g., if the terminal does not include a ST. For example the token holder may provide station 110 (FIG. 1) with the entered CHV data using input 115 (FIG. 1), e.g., if terminal 111 does not include a ST. In another demonstrative embodiment of the invention, the token holder may provide the entered CHV data directly to the terminal. For example, the token holder may provide terminal 111 (FIG. 1) with the CHV data using user input 195 (FIG. 1).

As indicated at block 212, the method may also include providing the entered CHV data to the security token. In one example, station 110 (FIG. 1) may provide terminal 111 (FIG. 1) with a verification command, denoted VerifyWithTicket(CHV), including the entered CHV data, e.g., if the entered CHV data was provided to station 110 (FIG. 1). Terminal 111 (FIG. 1) may provide token 130 with the VerifyWithTicket(CHV) command. In another example, station 1110 (FIG. 1) may transfer to terminal 111 (FIG. 1) a pseudo verification command, denoted VerifyWithTicket(CHV′), including pseudo CHV data, denoted CHV′, e.g., if terminal 111 (FIG. 1) includes a ST. Terminal 111 (FIG. 1) may transfer to the token the VerifyWithTicket(CHV) command based on the entered CHV data received via user interface 195.

As indicated at block 214, the method may also include authenticating the entered CHV data of the VerifyWithTicket(CHV) command. For example, the token, e.g., token 130 (FIG. 1), may perform an authentication operation to authenticate the entered CHV data, e.g., by comparing the entered CHV data to CHV data stored by the token, e.g., CHV data 135 (FIG. 1). The authentication operation may be performed using any suitable authentication hardware and/or software, e.g., as are known in the art. For example, token application 103 (FIG. 1) may perform the authentication of the entered CHV data.

As indicated at block 216, the method may also include preventing access to one or more resources of the token, e.g. if authentication of the entered CHV data fails. For example, token application 103 (FIG. 1) may prevent access to protected resources 199 (FIG. 1), e.g., by setting security status indicator 197 (FIG. 1) to the “access deny” state.

As indicated at block 218, the method may also include providing the station with a message indicating the authentication of the CHV data has failed. For example, token application 103 (FIG. 1) may provide station application 101 (FIG. 1) with a “fail” status message, e.g., as is known in the art.

As indicated at block 222, the method may also include enabling access to one or more resources of the token, e.g., if authentication of the entered CHV data has succeeded. For example, token application 103 (FIG. 1) may enable access to protected resources 199 (FIG. 1), e.g., by setting security status indicator 197 (FIG. 1) to the “access enable” state.

As indicated at block 220, the method may also include providing the station with a message indicating the authentication of the CHV data has succeeded. For example, token application 103 (FIG. 1) may provide station application 101 (FIG. 1) with a “success” status message, e.g., as is known in the art.

As indicated at block 226, the method may also include generating an authentication ticket, e.g., if authentication of the entered CHV data has succeeded. For example, token application 103 (FIG. 1) may generate ticket 181 (FIG. 1) if authentication of the entered CHV data has succeeded.

As indicated at block 228, the method may also include internally storing the ticket by the token. For example, token application 103 (FIG. 1) may store ticket 181 (FIG. 1) in memory 133 (FIG. 1).

As indicated at block 224, the method may also include providing the station with a value corresponding to the generated ticket. For example, token application 103 (FIG. 1) may transfer to station application 101 (FIG. 1), e.g., via terminal 111 (FIG. 1) a ticket message corresponding to the generated authentication ticket. Although the invention is not limited in this respect, the value corresponding to the ticket may be securely provided to the station, e.g., using a secure communication channel between the station and the token. For example, token application 103 (FIG. 1) and/or station application 101 (FIG. 1) may establish a secure communication channel, e.g., using any suitable communication method or algorithm as known in the art.

As indicated at block 230, the method may also include storing at the station a cached ticket corresponding to the generated ticket. For example, station application 101 (FIG. 1) may store in memory 119 (FIG. 1) cached ticket value 187 (FIG. 1) corresponding to the generated ticket.

According to some demonstrative embodiments of the invention, the method may also include accessing the protected resources of the token. For example, station application 101 (FIG. 1) may access protected resources 199 (FIG. 1) of token 130 (FIG. 1), e.g., as long as status indicator 197 (FIG. 1) is at the “access enable” status. Station application 101 (FIG. 1) may implement any suitable access algorithm or method, e.g., as are known in the art, for example, to retrieve, delete, and/or change resources 199; and/or to add new resources to protected resources 199 (FIG. 1).

As indicated at block 234, the method may also include preventing access to one or more resources of the token, for example, after accessing the protected resources, e.g., at the end of the transaction. For example, token application 103 (FIG. 1) may prevent access to protected resources 199 (FIG. 1), e.g., by setting security status indicator 197 (FIG. 1) to the “access deny” state (“clearing the security status indicator”).

Although the invention is not limited in this respect, the cached ticket value may be implemented by the station, for example, instead of the CHV data, for accessing the token during one or more additional transactions, e.g., as described in detail below.

As indicated at block 239, the method may also include providing the token with a verification command, denoted Verify(ticket), including the cached ticket in order, for example, to authenticate another transaction attempt, e.g., during the session. For example, station application 101 (FIG. 1) may transfer the Verify(ticket) command including cached ticket 187 (FIG. 1) to token application 103 (FIG. 1), e.g., via terminal 111 (FIG. 1).

As indicated at block 236, the method may also include authenticating the ticket received from the station. For example, token application 103 (FIG. 1) may perform an authentication operation to authenticate the ticket received from station 110 (FIG. 1), e.g., by comparing the ticket received from station 110 (FIG. 1) to ticket 181 (FIG. 1). The authentication operation may be performed, for example, in analogy to the authentication of the entered CHV data as described above with reference to block 214.

As indicated at block 233, the method may include preventing access to the token, e.g., if the ticket received from the station is not authenticated. For example, token application 130 (FIG. 1) may prevent access to protected resources 199 (FIG. 1), e.g., by setting security status indicator 197 to the “access deny” state. In addition token application 103 (FIG. 1) may provide station application 101 (FIG. 1) with the failure status message.

As indicated at block 238, the method may also include enabling access to one or more resources of the token, e.g., if authentication of the ticket received from the station has succeeded. For example, token application 103 (FIG. 1) may enable access to protected resources 199 (FIG. 1), e.g., by setting security status indicator 197 to the “access enable” state. The method may also include providing the station with a message indicating the authentication of the ticket, as indicated at block 237. For example, token application 103 (FIG. 1) may provide station application 101 (FIG. 1) with the success status message. The method may also include accessing the protected resources of the token, e.g., as indicated at block 232. For example, after the ticket has been authenticated, station application 101 (FIG. 1) may access protected resources 199 (FIG. 1), as described above.

According to some demonstrative embodiments of the invention, the station may perform one or more transactions by using the cached ticket value to authenticate access attempts to the protected resources of the token, e.g., as long as the ticket is valid by the token. As indicated at block 268, the token may invalidate the ticket, e.g., based on any suitable criteria. Token application 103 (FIG. 1) may invalidate the ticket, for example, by deleting ticket 181 (FIG. 1). In one example, token application 103 (FIG. 1) may invalidate ticket 181 (FIG. 1) at the end of a session, e.g., if the communication between token 130 (FIG. 1) and station 110 (FIG. 1) is disrupted or terminated. In another example, token application 103 (FIG. 1) may invalidate ticket 181 (FIG. 1) after a predefined time period has passed since the ticket has been generated. Accordingly, if the ticket is invalidated by the token, the holder of the token may be required to re-enter the CHV data in order to allow the station access to protected resources 199 (FIG. 1). Although the invention is not limited in this respect, in some demonstrative embodiments of the invention ticket 181 (FIG. 1) may be deleted or cleared, for example, if token 130 (FIG. 1) is disconnected from power source 116 (FIG. 1), e.g., if token 130 (FIG. 1) is disconnected from terminal 11 (FIG. 1).

It will be appreciated by those skilled in the art, that any combination of all or part of the actions described above with reference to FIG. 2 may be implemented to access a security token, according to embodiments of the invention. Further, other actions or series of actions may be used.

According to some demonstrative embodiments of the invention, the method described above with reference to FIG. 2 may enable the use of a ticket having a format, which may be different, for example, than a format of the CHV data. Accordingly, the ticket may have a predefined format or type for representing CHV data of different formats or types, e.g., PIN codes, biometric CHV data and the like. For example, a ticket having a relatively small data size, e.g., 64 bits, may be implemented to represent CHV data, e.g., biometric CHV data, which may have a relatively large data size.

It will be noted that in some cases the CHV data may be directly related to the user, and/or it may be complicated or impossible to redefine the CHV data for the user, for example, if the CHV data includes biometric CHV data, e.g., a fingerprint of the user. In such cases it may be desired to protect the CHV data from disclosure to an attacker. In contrast to the CHV data, the authentication ticket may by generated, e.g., randomly, such that the authentication ticket may not be related to the user. Thus, the use of the authentication ticket may obviate the disclosure of the CHV data, e.g., compared to the conventional methods of accessing a token.

It will be appreciated by those of ordinary skill in the art, that the method described above with reference to FIG. 2 may obviate storing the entered CHV data by the station, e.g., as may be required by conventional methods of accessing a security token. Thus, the method described above with reference to FIG. 2 may enhance the level of protection against unauthorized disclosure of the CHV data to an attacker, compared to the conventional methods.

It will also be appreciated by those of ordinary skill in the art that the method described above with reference to FIG. 2 may improve the level of convenience for the holder of the token, since the holder may be required to enter the CHV data, for example, only once, e.g., before a first transaction in a session, to enable performing one or more additional transactions, e.g., during the session.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A security token to securely maintain one or more protected resources, said security token comprising:
a token application to authenticate a first request to access said protected resources based on user authentication data assigned to a user of said security token, generate an output including an authentication ticket different from said user authentication data, and authenticate a second request to access said protected resources based on said authentication ticket.

2. The security token of claim 1, wherein said token application is able to invalidate said authentication ticket based on predefined criteria, and to deny one or more requests to access said protected resources using the invalid authentication ticket.

3. The security token of claim 2, wherein said security token receives said authentication data during a session with a station, and wherein said token application is able to invalidate said authentication ticket if said session is terminated.

4. The security token of claim 3, wherein said token application is able to invalidate said authentication ticket if communication with said station is disrupted or terminated.

5. The security token of claim 2, wherein said token application is able to invalidate said authentication ticket a predefined time period after generating said authentication ticket.

6. The security token of claim 1, wherein said token application generates a success status message indicating that access to said protected resources is allowed.

7. The security token of claim 1, wherein said user authentication data comprises card-holder-verification data.

8. The security token of claim 1, wherein a data size of said authentication ticket is smaller than a data size of said user authentication data.

9. The security token of claim 1, wherein the data size of said authentication ticket is smaller than or equal to 128 bits.

10. The security token of claim 9, wherein the data size of said authentication ticket is smaller than or equal to 64 bits.

11. The security token of claim 1 comprising a token selected from the group consisting of a universal-serial-bus token and a secure-digital token.

12. A method of accessing one or more protected resources of a security token, the method comprising:
providing said security token with user authentication data to authenticate a first request to access said protected resources;
receiving from said security token an authentication ticket different from said user authentication data; and
providing said security token with said ticket to authenticate a second request to access said protected resources subsequent to said first request.

13. The method of claim 12 comprising maintaining a value corresponding to said authentication ticket externally to said security token.

14. The method of claim 12 comprising invalidating said authentication ticket based on predefined criteria, wherein said invalidating results in denying one or more requests to access said protected resources using said authentication ticket.

15. The method of claim 14, wherein providing said authentication data comprises providing said authentication data during a session with said security token, and wherein invalidating said authentication ticket comprises invalidating said authentication ticket if said session is terminated.

16. The method of claim 15, wherein invalidating said authentication ticket comprises invalidating said authentication ticket if communication with said security token is disrupted or terminated.

17. The method of claim 14, wherein invalidating said authentication ticket comprises invalidating said authentication ticket a predefined time period after said authentication ticket has been provided by said security token.

18. The method of claim 12 comprising receiving from said security token a success status message indicating that access to said protected resources is allowed.

19. The method of claim 12 comprising receiving said user authentication data from a user of said security token.

20. The method of claim 12, wherein providing said user authentication data comprises providing card-holder-verification data.

21. The method of claim 12, wherein a data size of said authentication ticket is smaller than a data size of said user authentication data.

22. The method of claim 12, wherein the data size of said authentication ticket is smaller than or equal to 128 bits.

23. The method of claim 22, wherein the data size of said authentication ticket is smaller than or equal to 64 bits.

24. A system comprising:
a station; and
a security token assigned to a user,
wherein said security token is able to authenticate a first request from said station to access said protected resources based on user authentication data assigned to said user, provide said station with an authentication ticket different from said user authentication data, and authenticate a second request from said station to access said protected resources based on said authentication ticket.

25. The system of claim 24, wherein said station is able to maintain said authentication ticket, and generate said second request including said authentication ticket.

26. The system of claim 24 comprising a token terminal to couple said token to said station.

27. The system of claim 26, wherein said token terminal comprises a secure token terminal able to receive said authentication data directly from said user.

28. The system of claim 24, wherein said security token is able to invalidate said authentication ticket based on predefined criteria, and to deny one or more requests to access said protected resources using the invalid authentication ticket.

29. The system of claim 24, wherein the data size of said authentication ticket is smaller than or equal to 128 bits.

30. The system of claim 29, wherein the data size of said authentication ticket is smaller than or equal to 64 bits.

31. A machine-readable medium having stored thereon instructions, which when executed by a machine result in:
authenticating a first request to access one or more protected resources of a security token based on user authentication data assigned to a user of said security token;
generating an output including an authentication ticket different from said user authentication data; and
authenticating a second request to access said protected resources based on said authentication ticket.

32. The machine-readable medium of claim 31, wherein said instructions result in invalidating said authentication ticket based on predefined criteria, and denying one or more requests to access said protected resources using the invalid authentication ticket.

33. The machine-readable medium of claim 31, wherein a data size of said authentication ticket is smaller than a data size of said user authentication data.

34. The machine-readable medium of claim 31, wherein the data size of said authentication ticket is smaller than or equal to 128 bits.

35. A station able to communicate with a security token, said station comprising:
a station application to generate a request communication to access one or more protected resources of said security token, said communication comprising an authentication ticket able to authenticate said request, wherein said authentication ticket is different from user authentication data assigned to authenticate a user of said security token.

36. The station of claim 35, wherein said user authentication data comprises card-holder-verification data assigned to said user.

37. The station of claim 35, wherein the data size of said authentication ticket is equal to or smaller than 128 bits.
